(19) United States
(12) Patent Application Publication
(10) Pub. No.: US 2021/0226791 A1
(43) Pub. Date: Jul. 22, 2021

(54) ENCRYPTION SYSTEM, ENCRYPTION APPARATUS, DECRYPTION APPARATUS, ENCRYPTION METHOD, DECRYPTION METHOD, AND PROGRAM

(71) Applicant: NIPPON TELEGRAPH AND TELEPHONE CORPORATION, Tokyo (JP)

(72) Inventor: Keita KUSAGAWA, Tokyo (JP)

(73) Assignee: NIPPON TELEGRAPH AND TELEPHONE CORPORATION, Tokyo (JP)

(21) Appl. No.: 17/054,741

(22) PCT Filed: Apr. 24, 2019
(86) PCT No.: PCT/JP2019/017468

§ 371 Date: Nov. 11, 2020

(30) Foreign Application Priority Data
May 18, 2018 (JP) 2018-096219

(51) Int. Cl. H04L 9/30

(52) U.S. Cl. CPC H04L 9/3093

(57) ABSTRACT

An encryption system includes: key generation means for, assuming that Df and Dg are subsets of a ring R=Z[x]/(f(x)) (wherein f(x) is a predetermined polynomial of degree n), p and q are coprime positive integers and satisfy p<q, and f′ and g′ are elements of the R, by using an element f=p·f′ which is selected randomly from the Df, an element g=1+p·g′ which is selected randomly from the Dg, and the inverse Fq of the f in modulo q, generating h=g·Fq (mod q) as a public key and generating the f as a private key; encryption means for, assuming that Dr is a subset of the R, generating an encrypted message c=roundp(h·r) by using an element r selected from the Dr and the h; and decryption means for decrypting the encrypted message c by calculating r=a (mod p) after calculating a=f·c (mod q) by using the encrypted message c.

### TECHNICAL FIELD

The present invention relates to an encryption system, an encryption device, a decryption device, an encryption method, a decryption method, and a program.

### BACKGROUND ART

Conventionally, there is known NTRUEncrypt which is public key cryptography which uses difficulty of the shortest vector problem in a lattice defined by using a polynomial ring (NPL 1). In recent years, NTRUEncrypt attracts attention as a candidate for post-quantum cryptography.

In addition, there is also known a method called Rounded NTRU capable of increasing the speed of time required for decryption by using a Round function in encryption by NTRUEncrypt (NPL 2).

### CITATION LIST

### Non Patent Literature

[NPL 1] Jeffrey Hoffstein, Jill Pipher, Joseph H. Silverman: NTRU: A Ring-Based Public Key Cryptosystem., In ANTS 1998, pages 267-288. 1998.

[NPL 2] Daniel J. Bernstein, Chitchanok Chuengsatiansup, Tanja Lange, Christine van Vredendaal: NTRU Prime: Reducing Attack Surface at Low Cost. In SAC 2017, pages 235-260. 2017.

### SUMMARY OF THE INVENTION

### Technical Problem

Incidentally, in recent years, encryption and decryption of communication are often requested also in equipment such as IoT equipment in which hardware resources are relatively poor. Accordingly, NTRUEncrypt which allows processing to be performed at higher speed and has low memory usage is expected to be implemented.

An embodiment of the present invention is achieved in view of the above points, and an object thereof is to increase the speed of decryption processing of NTRUEncrypt and reduce the size of a private key.

### Means for Solving the Problem

In order to attain the above object, an embodiment of the present invention includes: key generation means for, assuming that Df and Dg are subsets of a ring R=Z[x]/(f(x)) (wherein f(x) is a predetermined polynomial of degree n), p and q are coprime positive integers and satisfy p<q, and f′ and g′ are elements of the R, by using an element f=p·f′ which is selected randomly from the Df, an element g=1+p·g′ which is selected randomly from the Dg, and the inverse Fq of the f in modulo q, generating h=g·Fq (mod q) as a public key and generating the f as a private key; encryption means for, assuming that Dr is a subset of the R, generating an encrypted message c=roundp(h·r) by using an element r selected from the Dr and the h; and decryption means for decrypting the encrypted message c by calculating r=a (mod p) after calculating a=f·c (mod q) by using the encrypted message c.

### Effects of the Invention

According to the embodiment of the present invention, it is possible to increase the speed of the decryption processing of NTRUEncrypt and reduce the size of the private key.

### BRIEF DESCRIPTION OF DRAWINGS

[FIG. 1]

FIG. 1 is a view showing an example of the overall configuration of an encryption system in an embodiment of the present invention.

[FIG. 2]

FIG. 2 is a view showing an example of the hardware configuration of each of an encryption device and a decryption device in the embodiment of the present invention.

[FIG. 3]

FIG. 3 is a view showing an example of the functional configuration of the encryption system in the embodiment of the present invention. [FIG. 4]

FIG. 4 is a sequence diagram (Example 1) showing an example of encryption and decryption processing in the embodiment of the present invention.

[FIG. 5]

FIG. 5 is a sequence diagram (Example 2) showing an example of the encryption and decryption processing in the embodiment of the present invention.

### DESCRIPTION OF EMBODIMENTS

Hereinbelow, an embodiment of the present invention will be described. In the embodiment of the present invention, a description will be given of an encryption system 1 capable of increasing the speed of decryption processing of NTRUEncrypt and reducing the size of a private key.

<Conventional Method of NTRUEncrypt>

Before description of a method of NTRUEncrypt in the embodiment of the present invention, several conventional methods of NTRUEncrypt will be described. In the following description, let n be a security parameter, and let R be a ring. The ring R is defined as R:=Z[x]/(f(x)) by using an integer coefficient polynomial ring Z[x]. Herein, (f(x)) is an ideal produced by f(x). f(x) is assumed to be a predetermined polynomial of degree n such as, e.g., f(x)=xn−1, f(x)=xn+1, f(x)=xn−x−1, or f(x)=xn+xn−1+ . . . +x+1.

In addition, p and q are assumed to satisfy p<q, and be coprime positive integers. Examples of p and q include p=3 and q=210.

Further, in the case where D is a proper subset of the ring R, random selection of an element f of the ring R from D is represented by “f←RD”. In addition, addition of elements of the ring R is represented by “+”, and multiplication thereof is represented by “·”.

(1) NTRUEncrypt

In NTRUEncrypt disclosed in NPL 1, key generation, encryption, and decryption are performed in the following manner.

(Key Generation)

Assuming that f←RDf and g←RDg are performed, h:=g·Fg (mod q) is calculated. Herein, Df and Dg are subsets of a ring R, and Fq is the inverse of f in modulo q (i.e., an element satisfying f·Fq=1 (mod q)).

Let h be a public key, and let f and Fp be private keys. Herein, Fp is the inverse of f in modulo p (i.e., an element satisfying f·Fp=1 (mod p)).

Note that, instead of generating Fp as the private key in advance, Fp may be calculated from f in decryption. However, in this case, calculation time for calculating Fp from f is required in decryption.

(Encryption)

By using (r, e), an encrypted message c:=p·h·r+e (mod q) is calculated. Herein, r is an element of a subset Dr of the ring R. In addition, e is an element of a subset De of the ring R, and is a target message to be encrypted. (r, e) are selected by a transmission side of the encrypted message (i.e., equipment or a device which generates and transmits the encrypted message). As (r, e), for example, assuming that Dr and De are the subsets of the ring R, r may be an element obtained by r←RDr, and e may be an element selected from De. Note that De is the set of target messages to be encrypted (e.g., the set of plaintext or the like).

(Decryption)

A reception side of the encrypted message c (i.e., equipment or a device which receives and decrypts the encrypted message) decrypts the encrypted message c to the message e by Step 1-1 and Step 1-2 described below.

Step 1-1) a:=f·c (mod q) is calculated. Note that f·c=p·f·h·r+f·e=p·g·r+f·e (mod q) is satisfied.

Step 1-2) e:=a·Fp (mod p) is calculated. With this, the message e is obtained. Note that, if necessary, r=(c−e)/(p·h) may be calculated.

(2) NTRUEncrypt of f=1+p·f′ Type

As a conventional method obtained by modifying part of the method of NTRUEncrypt in (1) described above, there is NTRUEncrypt in which f is limited to the form of 1+p·f′ (this NTRUEncrypt is described as “NTRUEncrypt of f=1+p·f′ type”). Herein, f′ is an element of a ring R.

In this case, the inverse Fp of f in modulo p is always 1. This is because f=1 (mod p) is satisfied. Consequently, NTRUEncrypt of f=1+p·f′ type has the advantage that, compared with NTRUEncrypt described above, the private key does not need to include Fp, and the multiplication of Fp in Step 1-2 described above becomes unnecessary.

(Key Generation)

Assuming that f=1+p·f′←RDf and g←RDg are performed, h:=g·Fq (mod q) is calculated. Herein, Df and Dg are subsets of the ring R, and Fq is the inverse of f in modulo q.

Let h be a public key, and let f be a private key.

(Encryption)

By using (r, e), an encrypted message c:=p·h·r+e (mod q) is calculated. Herein, r is an element of a subset Dr of the ring R. In addition, e is an element of a subset De of the ring R, and is a target message to be encrypted. (r, e) are selected by the transmission side of the encrypted message.

(Decryption)

The reception side of the encrypted message c decrypts the encrypted message c to the message e by Step 2-1 and Step 2-2 described below.

Step 2-1) a:=f·c (mod q) is calculated. Note that f·c=p·f·h·r+f·e=p·g·r+(1+p·f′)·e=e+p·(g·r+f′·e) (mod q) is satisfied.

Step 2-2) e:=a (mod p) is calculated. With this, the message e is obtained. Note that, if necessary, r=(c−e)/(p·h) may be calculated.

(3) Rounded NTRU

In Rounded NTRU disclosed in NPL 2, e is defined by using a Round function in encryption. That is, in Rounded NTRU, e is uniquely determined from p·h·r. Herein, assuming that roundp (·) is the Round function, roundp(a) is assumed to be a function which rounds a ∈ Zq to the nearest multiple of p. Specific examples of the calculation include round3(−5)=−6, round3(4)=3, and the like.

(Key Generation)

Assuming that f=p·f′←RDf and g←RDg are performed, h:=g·Fq (mod q) is calculated. Herein, Df and Dg are subsets of a ring R, and Fq is the inverse of f in modulo q.

Let h be a public key, and let f and Gp be private keys. Herein, Gp is the inverse of g in modulo p (i.e., an element satisfying g·Gp=1 (mod p)).

(Encryption)

By using r, an encrypted message c:=roundp(h·r) is calculated. Herein, r is an element of a subset Dr of the ring R, and is a target message to be encrypted. r is selected by the transmission side of the encrypted message. As r, for example, assuming that Dr is the subset of the ring R, r may be an element selected from Dr. Note that, in Rounded NTRU, Dr is the set of target messages to be encrypted (e.g., the set of plaintext or the like).

Herein, as described above, e is uniquely determined by roundp(h·r). That is, roundp(h·r)=h·r+e is satisfied.

(Decryption)

The reception side of the encrypted message c decrypts the encrypted message c to the message r by Step 3-1 to Step 3-3 described below.

Step 3-1) a:=f·c (mod q) is calculated. Note that f·c=(p·f′)·(h·r+e)=g·r+p·f′·e (mod q) is satisfied.

Step S3-2) a′: a (mod p) is calculated. Note that a=g·r (mod p) is satisfied.

Step 3-3) r:=a′·Gp (mod p) is calculated. With this, the message r is obtained.

(4) Rounded NTRU+Dent 4

It is also possible to apply Key Encapsulation Mechanism (KEM) described in Table 4 in Reference Document 1 shown below to Rounded NTRU in (3) described above.

[Reference Document 1] Alexander W. Dent: A Designer's Guide to KEMs, http://eprint.iacr.org/2002/174

NTRUEncrypt obtained by applying the above key encapsulation mechanism to Rounded NTRU is described as “Rounded NTRU+Dent 4”.

(Key Generation)

Assuming that f=p·f′←RDf and g←RDg are performed, h:=g·Fq (mod q) is calculated. Herein, Df and Dg are subsets of a ring R, and Fq is the inverse of f in modulo q.

Let h be a public key, and let h, f, and Gp be private keys. Herein, Gp is the inverse of g in modulo p.

(Encryption (Key Encapsulation))

Assuming that r←RDr is performed, c1:=roundp(h·r) is calculated. In addition, (c2, K):=H(r) is calculated. Herein, Dr is a subset of the ring R, and H(·) is a hash function.

In addition, an encrypted message is given by c: (c1, c2), and let K be a shared key. Note that, with regard to (c2, K), in the case where L1 is a bit length obtained by H(r) and L2 is the bit length of the shared key, in a bit string obtained by H(r), c2 may be a bit string from the 0-th bit to the (L1−L2−1)-th bit, and K may be a bit string from the (L1−L2)-th bit to the (L1−1)-th bit.

Herein, as described above, e is uniquely determined by roundp(h·r). That is, roundp(h·r)=h·r+e is satisfied.

(Decryption (Key Decapsulation))

The reception side of the encrypted message c performs key decapsulation by Step 4-1 to Step 4-5 described below to generate a shared key.

Step 4-1) a:=f·c (mod q) is calculated. Note that f·c=(p·f′)·(h·r+e)=g·r+p·f′·e (mod q) is satisfied.

Step 4-2) a′: a (mad p) is calculated. Note that a=g·r (mod p) is satisfied.

Step 4-3) r′:=a′·Gp (mod p) is calculated.

Step 4-4) By performing the key capsulation by using r′, c1′, c2′, and K′ are obtained. That is, c1′, c2′, and K′ are obtained by calculating c1′:=roundp(h·r′) and (c2′, K′):=H(r′).

Step 4-5) In the case where r′ ∈ Dr and (c1, c2)=(c1′, c2′) are satisfied, K′ is the shared key. With this, the shared key K=K′ is shared between the reception side and the transmission side of the encrypted message c. Note that, in the case where at least one of r′ ∈ Dr and (c1, c2)=(c1′, c2′) is not satisfied, it is determined that decryption has failed (key decapsulation failure).

<Method of NTRUEncrypt in Embodiment of Present Invention>

Next, in a method of NTRUEncrypt in the embodiment of the present invention, Rounded NTRU in (3) described above is improved and a private key is change to only f. With this, the method of NTRUEncrypt has the advantage that, compared with Rounded NTRU in (3) described above, it is not necessary to store Gp as the private key, and Step 3-3 described above becomes unnecessary. That is, in the method of NTRUEncrypt in the embodiment of the present invention, it is possible to increase the speed of decryption processing, and reduce the size of the private key.

(Key Generation)

Assuming that f=p·f′←RDf and g=1+p·g′←RDg are performed, h:=g·Fq (mod q) is calculated. Herein, Df and Dg are subsets of a ring R, g′ is an element of the ring R, and Fq is the inverse of f in modulo q.

Let h be a public key, and let f be a private key. Thus, compared with Rounded NTRU in (3) described above, Gp serving as the private key is not necessary, and hence it is possible to reduce the size of the private key. In other words, it is possible to reduce a storage area required for storage of the private key. Note that, in addition to f, g may also be the private key.

(Encryption)

By using r, an encrypted message c:=roundp(h·r) is calculated. Herein, r is an element of a subset Dr of the ring R, and is a target message to be encrypted. r is selected by the transmission side of the encrypted message. As r, for example, assuming that Dr is the subset of the ring R, r may be an element selected from Dr. Note that, in NTRUEncrypt in the embodiment of the present invention, similarly to ROUNDED NTRU in (3) described above, Dr is the set of target messages to be encrypted (e.g., the set of plaintext or the like).

Herein, similarly to Rounded NTRU in (3) described above, e is uniquely determined by roundp(h·r). That is, roundp(h·r)=h·r+e is satisfied.

(Decryption)

The reception side of the encrypted message c decrypts the encrypted message c to the message r by Step 5-1 to Step 5-3 described below.

Step 5-1) a:=f·c (mod q) is calculated. Note that f·c=(p·f′)·(h·r+e)=p·f′·h·r+p·f′·e=(1+p·g′)·r +p·f′·e=r+p·(g′·r+f′·e) (mod q) is satisfied.

Step 5-2) r:=a (mod p) is calculated. With this, the message r is obtained. Thus, compared with Rounded NTRU in (3) described above, Step 3-3 described above is not necessary, and hence it becomes possible to perform decryption processing at higher speed.

<Method of NTRUEncrypt in Embodiment of Present Invention+Dent 4>

It is possible to apply the key encapsulation mechanism described in Table 4 in Reference Document 1 described above to NTRUEncrypt in the embodiment of the present invention. NTRUEncrypt obtained by applying the key encapsulation mechanism to NTRUEncrypt in the embodiment of the present invention is described as “Rounded NTRU in the embodiment of the present invention+Dent 4”.

(Key Generation)

Assuming that f=p·f′←RDf and g=1+p·g′←RDg are performed, h:=g·Fq (mod q) is calculated. Herein, Df and Dg are subsets of a ring R, g′ is an element of the ring R, and Fq is the inverse of f in modulo q.

In addition, let h be a public key, and let h and f be private keys. Thus, compared with Rounded NTRU+Dent 4 in (4) described above, Gp serving as the private key is not necessary, and hence it is possible to reduce the size of the private key. In other words, it is possible to reduce a storage area required for storage of the private key. Note that, in addition to f, g may also be the private key.

(Encryption (Key Encapsulation))

Assuming that r←RDr is performed, c1:=roundp(h·r) is calculated. In addition, (c2, K):=H(r) is calculated. Herein, Dr is a subset of the ring R, and H(·) is a hash function.

Further, an encrypted message is given by c:=(c1, c2), and let K be a shared key.

Herein, as described above, e is uniquely determined by roundp(h·r). That is, roundp(h·r)=h·r+e is satisfied.

(Decryption (Key Decapsulation))

The reception side of the encrypted message c performs key decapsulation by Step 6-1 to Step 6-4 described below to generate a shared key.

Step 6-1) a:=f·c (mod q) is calculated. Note that f·c=(p·f′)·(h·r+e)=(1+p·g′)·r+p·f′·e=r+p·(g′·r +f′·e) (mod q) is satisfied.

Step 6-2) r′: a (mod p) is calculated.

Step 6-3) By performing key encapsulation by using r′, c1′, c2′, and K′ are obtained. That is, c1′, c2′, and K′ are obtained by calculating c1′:=roundp(h·r′) and (c2′, K′):=H(r′).

Step 6-4) In the case where r′ ∈ Dr and (c1, c2)=(c1′, c2′) are satisfied, K′ is the shared key. With this, the shared key K=K′ is shared between the reception side and the transmission side of the encrypted message c. Note that, in the case where at least one of r′ ∈ Dr and (c1, c2)=(c1′, c2′) is not satisfied, it is determined that decryption has failed (key decapsulation failure).

Thus, compared with Rounded NTRU+Dent 4 in (4) described above, Step 4-3 described above is not necessary, and hence it becomes possible to perform decryption processing (key decapsulation processing) at higher speed.

<Overall Configuration>

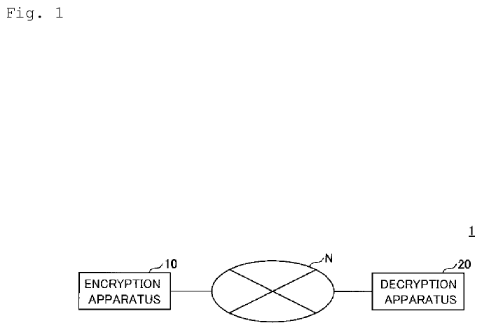

Next, a description will be given of the overall configuration of an encryption system 1 in the embodiment of the present invention with reference to FIG. 1. FIG. 1 is a view showing an example of the overall configuration of the encryption system 1 in the embodiment of the present invention.

As shown in FIG. 1, the encryption system 1 in the embodiment of the present invention includes one or more encryption devices 10, and one or more decryption devices 20. The encryption device 10 and the decryption device 20 are connected to each other so as to be capable of communicating with each other via a wide area network N such as, e.g., the Internet.

The encryption device 10 is one of various devices or equipment which performs generation of a public key and decryption of an encrypted message. On the other hand, the decryption device 20 is one of various devices or equipment which performs encryption of a message.

As each of the encryption device 10 and the decryption device 20, any device or equipment capable of communicating with another device or equipment is used. IoT equipment such as, e.g., a PC (personal computer), a smartphone, a tablet, a wearable device, game equipment, a household appliance, a car navigation terminal, or a sensor device is used.

<Hardware Configuration>

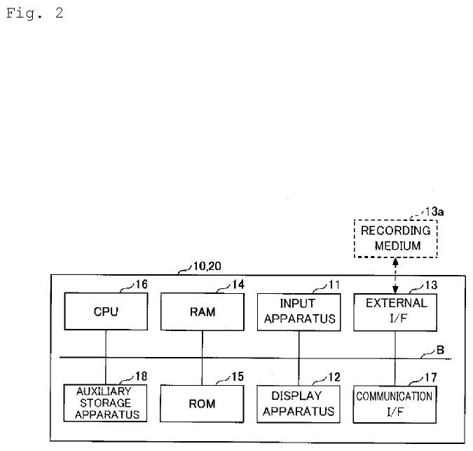

Next, a description will be given of the hardware configuration of each of the encryption device 10 and the decryption device 20 in the embodiment of the present invention with reference to FIG. 2. FIG. 2 is a view showing an example of the hardware configuration of each of the encryption device 10 and the decryption device 20 in the embodiment of the present invention. Note that the encryption device 10 and the decryption device 20 can be implemented by using substantially the same hardware configurations, and hence the hardware configuration of the encryption device 10 will be mainly described in the following description.

As shown in FIG. 2, the encryption device 10 in the embodiment of the present invention has an input device 11, a display device 12, an external I/F 13, a RAM (Random Access Memory) 14, a ROM (Read Only Memory) 15, a CPU (Central Processing Unit) 16, a communication I/F 17, and an auxiliary storage device 18. These pieces of hardware are connected to each other so as to be capable of communicating with each other via a bus B.

The input device 11 is, e.g., a keyboard, a mouse, or a touch panel. The display device 12 is, e.g., a display or the like. Note that each of the encryption device 10 and the decryption device 20 may not have at least one of the input device 11 and the display device 12.

The external I/F 13 is an interface with an external device. The external device includes a recording medium 13a or the like. Examples of the recording medium 13a include a CD (Compact Disc), a DVD (Digital Versatile Disk), an SD memory card (Secure Digital memory card), and a USB (Universal Serial Bus) memory card. In the recording medium 13a, one or more programs for implementing the individual functions of the encryption device 10 and one or more programs for implementing the individual functions of the decryption device 20 may be recorded.

The RAM 14 is a volatile semiconductor memory which temporarily retains programs and data. The ROM 15 is a non-volatile semiconductor memory capable of retaining programs and data even when the power is turned off.

The CPU 16 is an operation device which reads programs and data from the ROM 15 and the auxiliary storage device 18 into the RAM 14 and executes processing.

The communication I/F 17 is an interface for connection to the network N. Note that one or more programs for implementing the individual functions of the encryption device 10 and one or more programs for implementing the individual functions of the decryption device 20 may be acquired (downloaded) from a predetermined server or the like via the communication I/F 17.

The auxiliary storage device 18 is a non-volatile storage device such as, e.g., a HDD (Hard Disk Drive) or a SSD (Solid State Drive). In the auxiliary storage device 18, one or more programs for implementing the individual functions of the encryption device 10 are stored. Note that, in the auxiliary storage device 18 of the decryption device 20, one or more programs for implementing the individual functions of the decryption device 20 are stored.

Each of the encryption device 10 and the decryption device 20 in the embodiment of the present invention can implement various processing described later by having the hardware configuration shown in FIG. 2. Note that FIG. 2 shows the case where the encryption device 10 and the decryption device 20 in the embodiment of the present invention are implemented by one information processing device (computer), but the encryption device 10 and the decryption device 20 in the embodiment of the present invention are not limited thereto. The encryption device 10 and the decryption device 20 in the embodiment of the present invention may be implemented by a plurality of information processing device (computers).

<Functional Configuration>

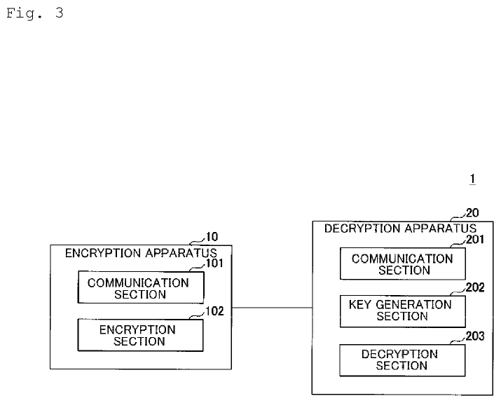

Next, a description will be given of the functional configuration of the encryption system 1 in the embodiment of the present invention with reference to FIG. 3. FIG. 3 is a view showing an example of the functional configuration of the encryption system 1 in the embodiment of the present invention.

As shown in FIG. 3, the encryption device 10 in the embodiment of the present invention has a communication section 101 and an encryption section 102. These individual sections are implemented by processing which one or more programs installed in the encryption device 10 causes the CPU 16 to execute.

The communication section 101 performs transmission and reception of various pieces of data with the decryption device 20. For example, the communication section 101 transmits an encrypted message to the decryption device 20.

The encryption section 102 generates the encrypted message with NTRUEncrypt in the embodiment of the present invention by using a public key which is made public by the decryption device 20.

As shown in FIG. 3, the decryption device 20 in the embodiment of the present invention has a communication section 201, a key generation section 202, and a decryption section 203. These individual sections are implemented by processing which one or more programs installed in the decryption device 20 cause the CPU 16 to execute.

The communication section 201 performs transmission and reception of various pieces of data with the encryption device 10. For example, the communication section 201 receives the encrypted message from the encryption device 10.

The key generation section 202 generates a public key and a private key with NTRUEncrypt in the embodiment of the present invention.

The decryption section 203 decrypts the encrypted message with NTRUEncrypt in the embodiment of the present invention by using the private key generated by the key generation section 202.

### Encryption And Decryption Processing (Example 1)

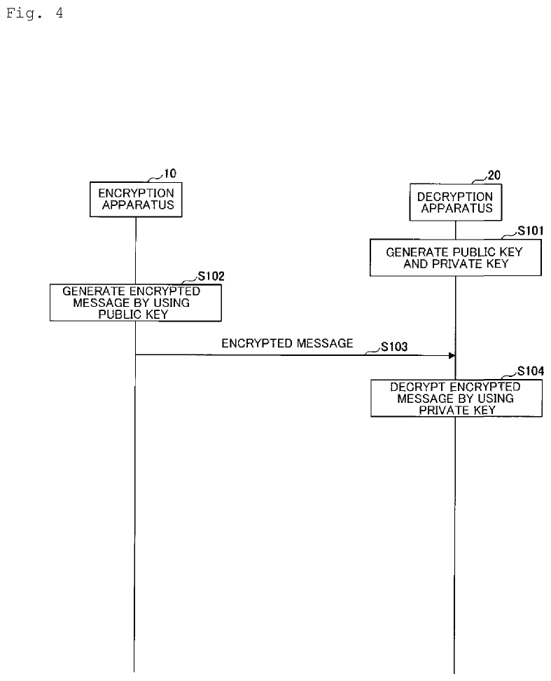

In the following description, as Example 1, a description will be given of processing in which encryption and decryption are performed with NTRUEncrypt in the embodiment of the present invention with reference to FIG. 4. FIG. 4 is a sequence diagram (Example 1) showing an example of encryption and decryption processing in the embodiment of the present invention.

First, the key generation section 202 of the decryption device 20 generates a public key h and a private key f (Step S101). That is, assuming that f=p·f′←RDf and g=1+p·g′←RDg are performed, the key generation section 202 calculates h:=g·Fq (mod q), and let h be the public key and let f be the private key. Herein, Df and Dg are subsets of a ring R, g′ is an element of the ring R, and Fq is the inverse of f in modulo q. Note that the public key h is made public to the encryption device 10.

Next, the encryption section 102 of the encryption device 10 encrypts a target message to be encrypted r ∈ Dr by using the public key h to generate an encrypted message c (Step S102). That is, the encryption section 102 calculates c:=roundp(h·r) to thereby generate the encrypted message c. Herein, Dr is a subset of the ring R.

Next, the communication section 101 of the encryption device 10 transmits the encrypted message c to the decryption device 20 (Step S103).

When the decryption section 203 of the decryption device 20 receives the encrypted message c from the communication section 201, the decryption section 203 decrypts the encrypted message c to the message r by Step 5-1 to Step 5-3 described above by using the private key f (Step S104).

### Encryption And Decryption Processing (Example 2)

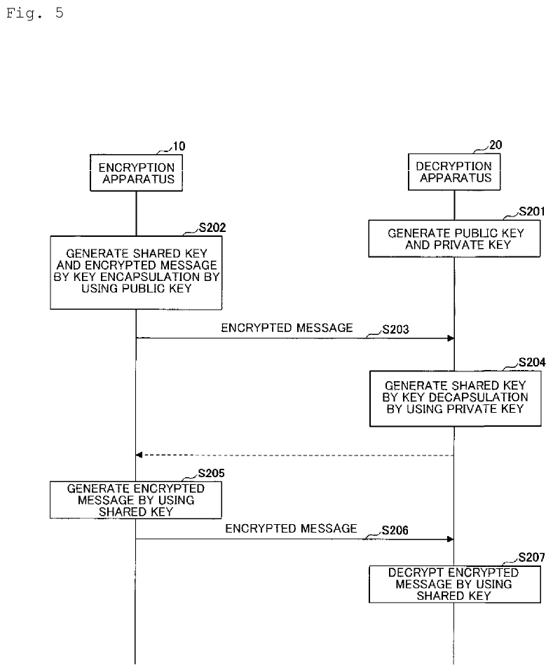

In the following description, as Example 2, a description will be given of processing in which a shared key is shared between the encryption device 10 and the decryption device 20 with NTRUEncrypt in the embodiment of the present invention+Dent 4, and encryption and decryption are then performed with the shared key with reference to FIG. 5. FIG. 5 is a sequence diagram (Example 2) showing an example of encryption and decryption processing in the embodiment of the present invention.

First, the key generation section 202 of the decryption device 20 generates a public key h and a private key f (Step S201). That is, assuming that f=p·f′←RDf and g=1+p·g′←RDg are performed, the key generation section 202 calculates h:=g·Fq (mod q), and let h be the public key and let f be the private key. Herein, Df and Dg are subsets of a ring R, g′ is an element of the ring R, and Fq is the inverse of f in modulo q. Note that the public key h is made public to the encryption device 10.

Next, the encryption section 102 of the encryption device 10 generates a shared key K and an encrypted message c by key encapsulation by using the public key h (Step S202). That is, assuming that r←RDr is performed, the encryption section 102 calculates c1:=roundp(h·r) and (c2, K):=H(r) to generate the encrypted message c:=(c1, c2) and the shared key K. Herein, Dr is a subset of the ring R, and H(·) is a hash function.

Next, the communication section 101 of the encryption device 10 transmits the encrypted message c to the decryption device 20 (Step S203).

When the decryption section 203 of the decryption device 20 receives the encrypted message c from the communication section 201, the decryption section 203 generates a shared key K=K′ from the encrypted message c by Step 6-1 to Step 6-4 described above by using the private key f (Step S204). Subsequently, the decryption section 203 notifies the encryption device 10 that the shared key K is obtained.

Next, the encryption section 102 of the encryption device 10 encrypts a target message to be encrypted by any encryption algorithm by using the shared key K to generate an encrypted message (Step S205).

Next, the communication section 101 of the encryption device 10 transmits the encrypted message to the decryption device 20 (Step S206).

When the decryption section 203 of the decryption device 20 receives the encrypted message from the communication section 201, the decryption section 203 decrypts the encrypted message by a decryption algorithm corresponding to the above encryption algorithm by using the shared key K (Step S207).

<Effect Of Present Invention>

Herein, as an example, a description will be given of the effect of the present invention in the case where a parameter set kem/ntrulpr4591761 described in Reference Document 2 shown below is used.

[Reference Document 2] Daniel J. Bernstein, Chitchanok Chuengsatiansup, Tanja Lange, Christine van Vredendaal: NTRU Prime NIST Submitted.

In the above parameter set kem/ntrulpr4591761, p=3, n=761, and q=4591 are satisfied, and f(x)=xn−x−1 is satisfied. In this case, as described in Reference Document 2 mentioned above, in conventional Rounded NTRU, a public key has 1218 bytes, an encrypted message has 1015 bytes, and a private key has 1600 bytes=1218+191+191 bytes.

In contrast to this, by using the method of NTRUEncrypt in the embodiment of the present invention, it is possible to reduce the size of the private key to 1409 bytes=1218+191 bytes.

The preset invention is not limited to the above embodiment which is specifically disclosed, and can be variously modified or changed without departing from the scope of claims.

### REFERENCE SIGNS LIST

1 Encryption system
10 Encryption device
20 Decryption device
101 Communication section
102 Encryption section
201 Communication section
202 Key generation section
203 Decryption section

1-8. (canceled)

9. A computer-implemented method for data encryption and decryption, the method comprising:
generating a public key, wherein the public key is based at least on:
a first value based on a first combination of a first coprime integer value and a first randomly selected value from a first subset of a ring based on a polynomial with a predetermined degree, and
a second value based on a second combination of a second coprime integer value, the second coprime integer being less than the first coprime integer value, a second randomly selected value from a second subset of the ring;
generating a private key, wherein the private key is based at least on the first value and without the second value;
generating an encrypted message data using the generated public key and a third randomly selected value from a third subset of the ring, wherein the encrypted message data includes data based on a shared key; and
transmitting the encrypted message data.

10. The computer-implemented method of claim 9, wherein the public key is based on an inverse of the first value in modulo of the second coprime integer.

11. The computer-implemented method of claim 9, the method further comprising:
generating the encrypted message data and the shared key data based at least on a combination of:
the third randomly selected value,
the public key, and
a predefined hash value.

12. The computer-implemented method of claim 9, the method further comprising:
generating, based the encrypted message data and the shared key, the decrypted message data and the shared key data.

13. The computer-implemented method of claim 9, the method further comprising:
when an inverse of the third randomly selected value is not a part of the third subset of the ring, determining a failure of generating the decrypted message data.

14. The computer-implemented method of claim 9, the method further comprising:
receiving the encrypted message data; and
generating, based on the encrypted message data, a decrypted message data using the generated private key and the shared key based on a key decapsulation, wherein the key decapsulation is without use of the second value.

15. The computer-implemented method of claim 9, wherein the encrypted message data is based at least on:
the public key,
the third subset of the ring, and
hash data including the shared key data.

16. A system for data encryption and decryption, the system comprises:
a processor; and
a memory storing computer-executable instructions that when executed by the processor cause the system to:
generate a public key, wherein the public key is based at least on:
a first value based on a first combination of a first coprime integer value and a first randomly selected value from a first subset of a ring based on a polynomial with a predetermined degree, and
a second value based on a second combination of a second coprime integer value, the second coprime integer being less than the first coprime integer value, a second randomly selected value from a second subset of the ring;
generate a private key, wherein the private key is based at least on the first value and without the second value;
generate an encrypted message data using the generated public key and a third randomly selected value from a third subset of the ring, wherein the encrypted message data includes data based on a shared key; and
transmit the encrypted message data.

17. The system of claim 16, wherein the public key is based on an inverse of the first value in modulo of the second coprime integer, and the computer-executable instructions when executed further causing the system to:
generate, based on the encrypted message data, a decrypted message data using the generated private key and the shared key based on a key decapsulation, wherein the key decapsulation is without use of the second value.

18. The system of claim 16, the computer-executable instructions when executed further causing the system to:
generate the encrypted message data and the shared key data based at least on a combination of:
the third randomly selected value,
the public key, and
a predefined hash value.

19. The system of claim 16, the computer-executable instructions when executed further causing the system to:
generate, based the encrypted message data and the shared key, the decrypted message data and the shared key data.

20. The system of claim 16, the computer-executable instructions when executed further causing the system to:
when an inverse of the third randomly selected value is not a part of the third subset of the ring, determine a failure of generating the decrypted message data; and
provide, based on the determination of the failure, a result of the generating the encrypted message data.

21. The system of claim 16, the computer-executable instructions when executed further causing the system to:
transmit the encrypted message data.

22. The system of claim 16, wherein the encrypted message data is based at least on:
the public key,
the third subset of the ring, and
hash data including the shared key data.

23. A computer-readable non-transitory recording medium storing computer-executable instructions that when executed by a processor cause a computer system to:
generate a public key, wherein the public key is based at least on:
a first value based on a first combination of a first coprime integer value and a first randomly selected value from a first subset of a ring based on a polynomial with a predetermined degree, and
a second value based on a second combination of a second coprime integer value, the second coprime integer being less than the first coprime integer value, a second randomly selected value from a second subset of the ring;
generate a private key, wherein the private key is based at least on the first value and without the second value;
generate an encrypted message data using the generated public key and a third randomly selected value from a third subset of the ring, wherein the encrypted message data includes data based on a shared key; and
transmit the encrypted message data.

24. The computer-readable non-transitory recording medium of claim 23, wherein the public key is based on an inverse of the first value in modulo of the second coprime integer, and the computer-executable instructions when executed further causing the system to:
generate, based on the encrypted message data, a decrypted message data using the generated private key and the shared key based on a key decapsulation, wherein the key decapsulation is without use of the second value.

25. The computer-readable non-transitory recording medium of claim 23, the computer-executable instructions when executed further causing the system to:
generate the encrypted message data and the shared key data based at least on a combination of:
the third randomly selected value,
the public key, and
a predefined hash value.

26. The computer-readable non-transitory recording medium of claim 23, the computer-executable instructions when executed further causing the system to:
generate, based the encrypted message data and the shared key, the decrypted message data and the shared key data.

27. The computer-readable non-transitory recording medium of claim 23, the computer-executable instructions when executed further causing the system to:
when an inverse of the third randomly selected value is not a part of the third subset of the ring, determine a failure of generating the decrypted message data; and
provide, based on the determination of the failure, a result of the generating the encrypted message data.

28. The computer-readable non-transitory recording medium of claim 23, wherein the encrypted message data is based at least on:
the public key,
the third subset of the ring, and
hash data including the shared key data.
